(19) United States
(12) Patent Application Publication
(10) Pub. No.: US 2010/0250633 A1
(43) Pub. Date: Sep. 30, 2010

(54) SYSTEMS AND METHODS FOR STORAGE OF NOTIFICATION MESSAGES IN ISO BASE MEDIA FILE FORMAT

(75) Inventors: Miska Matias Hannuksela, Ruutana (FI); Imed Bouazizi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/745,885

(22) PCT Filed: Dec. 2, 2008
(86) PCT No.: PCT/IB08/03304

§ 371 Date: Jun. 2, 2010

Related U.S. Application Data
(60) Provisional application No. 60/992,064, filed on Dec. 3, 2007.

(51) Int. Cl. G06F 17/30

(52) U.S. Cl. 707/825; 707/E17.01

(57) ABSTRACT

Systems and methods for storing notification messages in an ISO base media file are provided, where different transport cases when notification messages are to be stored are addressed. The systems and methods enable the linking of notification message parts delivered over RTP with other parts of a notification message carried over file delivery over unidirectional transport (FLUTE) or some other protocol. Various implementations of the systems and methods can be generic and allow objects delivered out-of-band to be referenced from media and hint tracks. Additionally the lifecycle of notification objects can be reproduced in the file without timers required in the parsing of the file.

### FIELD OF THE INVENTION

The present invention relates generally to the use of multimedia file formats. More particularly, the present invention relates to storing notification messages in an International Organization for Standardization (ISO) base media file.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The multimedia container file format is an important element in the chain of multimedia content production, manipulation, transmission and consumption. In this context, the coding format (i.e., the elementary stream format) relates to the action of a specific coding algorithm that codes the content information into a bitstream. The container file format comprises mechanisms for organizing the generated bitstream in such a way that it can be accessed for local decoding and playback, transferring as a file, or streaming, all utilizing a variety of storage and transport architectures. The container file format can also facilitate the interchanging and editing of the media, as well as the recording of received real-time streams to a file. As such, there are substantial differences between the coding format and the container file format.

Available media and container file format standards include the ISO base media file format (ISO/IEC 14496-12), the MPEG-4 file format (ISO/IEC 14496-14, also known as the MP4 format), Advanced Video Coding (AVC) file format (ISO/IEC 14496-15) and the 3GPP file format (3GPP TS 26.244, also known as the 3GP format). There is also a project in MPEG for development of the scalable video coding (SVC) file format, which will become an amendment to advanced video coding (AVC) file format. In a parallel effort, MPEG is defining a hint track format for file delivery over unidirectional transport (FLUTE) and asynchronous layered coding (ALC) sessions, which will become an amendment to the ISO base media file format.

The multimedia file formats provide a hierarchical file structure, enabling storage of multimedia data as well as information about multimedia, and hints on how to transport the multimedia. Notification messages, such as requests for voting or contextual advertisements, can either be synchronized to some Audio/Visual (A/V) content or can be a stand-alone service. One example of a standalone notification service is a stock market ticker that delivers share prices. However, notification messages may have a limited lifetime, e.g., voting requests may only be valid during a related TV program.

There is a need to develop a multimedia container format to enable storage of notification messages in addition to the audio-visual content for a full-featured consumption of the service at some later point.

### SUMMARY OF THE INVENTION

Various embodiments provide systems and methods for storing notification messages in an ISO base media file. Different transport cases when notification messages are to be stored can be addressed.

Various embodiments enable the linking of notification message parts delivered over RTP with other parts of a notification message carried over FLUTE (or some other protocol, e.g., Hypertext Transfer Protocol (HTTP)). Implementations of various embodiments can be generic and allow objects delivered out-of-band to be referenced from media and hint tracks. Moreover, various embodiments provide methods for the efficient storage of a received FLUTE session. By extracting and storing the transport objects of a FLUTE session, both redundancy and retrieval time can be reduced, while still preserving the timeline. Additionally still, various embodiments facilitate reproduction of the lifecycle of notification objects into the file without timers required in the parsing of the file. Such a feature of various embodiments simplifies operations such as random access and file editing.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of the hierarchy of multimedia file formats;

FIG. 2 illustrates an exemplary file structure in accordance with the ISO base media file format;

FIG. 3 is an exemplary hierarchy of boxes illustrating sample grouping in accordance with the ISO base media file format;

FIG. 4 illustrates an exemplary file containing a movie fragment including a SampletoToGroup box;

FIG. 5 is a representation of a notification message structure;

FIG. 6 illustrates a notification object lifecycle model;

FIG. 7 illustrates example lifecycles of two notification objects;

FIG. 8 illustrates a graphical representation of an exemplary multimedia communication system within which various embodiments be implemented;

FIG. 9 illustrates a method of linking notification message parts delivered over RTP and FLUTE within a file in accordance with various embodiments;

FIG. 10 illustrates the storage of FLUTE transport objects in an ISO base media file in accordance with various embodiments;

FIG. 11 is a flow chart illustrating processes for storing an incoming stream to a file in accordance with various embodiments.

FIG. 12 is a flow chart illustrating processes for parsing and/or processing of the file of FIG. 11;

FIG. 13 is a perspective view of an electronic device that can be used in conjunction with the implementation of various embodiments; and

FIG. 14 is a schematic representation of the circuitry which may be included in the electronic device of FIG. 13.

### DETAILED DESCRIPTION OF THE PREFERRED EMBODIMENTS

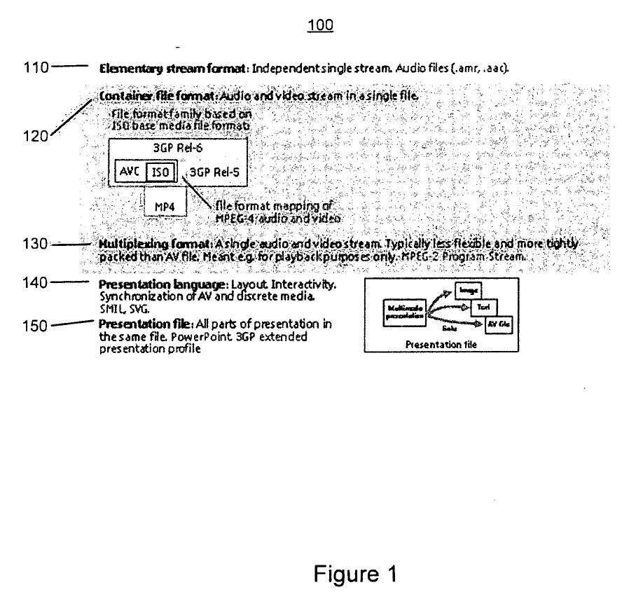

The hierarchy of multimedia file formats is depicted generally at 100 in FIG. 1. The elementary stream format 110 represents an independent, single stream. Audio files such as .amr and .aac files are constructed according to the elementary stream format. The container file format 120 is a format which may contain both audio and video streams in a single file. An example of a family of container file formats 120 is based on the ISO base media file format. Just below the container file format 120 in the hierarchy 100 is the multiplexing format 130. The multiplexing format 130 is typically less flexible and more tightly packed than an audio/video (ΔV) file constructed according to the container file format 120. Files constructed according to the multiplexing format 130 are typically used for playback purposes only. A Moving Picture Experts Group (MPEG)-2 program stream is an example of a stream constructed according to the multiplexing format 130. The presentation language format 140 is used for purposes such as layout, interactivity, the synchronization of AV and discrete media, etc. Synchronized multimedia integration language (SMIL) and scalable video graphics (SVG), both specified by the World Wide Web Consortium (W3C), are examples of a presentation language format 140. The presentation file format 150 is characterized by having all parts of a presentation in the same file. Examples of objects constructed according to a presentation file format are PowerPoint files and files conforming to the extended presentation profile of the 3GP file format.

Available media and container file format standards include the ISO base media file format (ISO/IEC 14496-12), the MPEG-4 file format (ISO/IEC 14496-14, also known as the MP4 format), Advanced Video Coding (AVC) file format (ISO/IEC 14496-15) and the 3GPP file format (3GPP TS 26.244, also known as the 3GP format). There is also a project in MPEG for development of the scalable video coding (SVC) file format, which will become an amendment to advanced video coding (AVC) file format. In a parallel effort, MPEG is defining a hint track format for file delivery over unidirectional transport (FLUTE) and asynchronous layered coding (ALC) sessions, which will become an amendment to the ISO base media file format. The basic building block in the ISO base media file format is called a box. Each box includes a header and a payload. The box header indicates the type of the box and the size of the box in terms of bytes. A box may enclose other boxes, and the ISO file format specifies which box types are allowed within a box of a certain type. Furthermore, some boxes are mandatorily present in each file, while other boxes are simply optional. Moreover, for some box types, there can be more than one box present in a file. Therefore, the ISO base media file format essentially specifies a hierarchical structure of boxes.

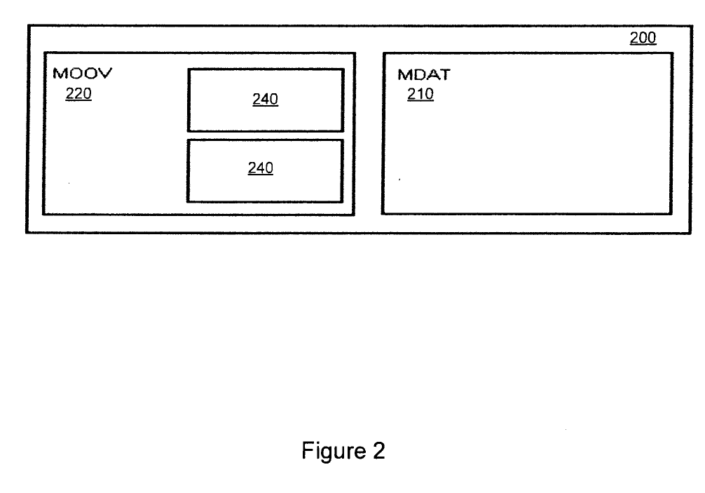

FIG. 2 shows a simplified file structure according to the ISO base media file format. According to the ISO family of file formats, a file 200 includes media data and metadata that are enclosed in separate boxes, the media data (mdat) box 210 and the movie (moov) box 220, respectively. For a file to be operable, both of these boxes must be present. The media data box 210 contains video and audio frames, which may be interleaved and time-ordered. The movie box 220 may contain one or more tracks, and each track resides in one track box 240. A track can be one of the following types: media, hint or timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced (e.g., a reference may indicate which piece of data in a particular track or item is instructed to be copied into a packet during the packet construction process). A timed metadata track refers to samples describing referred media and/or hint samples. For the presentation of one media type, typically one track is selected.

Additionally, samples of a track are implicitly associated with sample numbers that are incremented by 1 in an indicated decoding order of samples. Therefore, the first sample in a track can be associated with sample number “1.” It should be noted that such an assumption affects certain formulas, but one skilled in the art would understand to modify such formulas accordingly for other “start offsets” of sample numbers, e.g., sample number “0.”

It should be noted that the ISO base media file format does not limit a presentation to be contained in only one file. In fact, a presentation may be contained in several files. In this scenario, one file contains the metadata for the whole presentation. This file may also contain all of the media data, in which case the presentation is self-contained. The other files, if used, are not required to be formatted according to the ISO base media file format. The other files are used to contain media data, and they may also contain unused media data or other information. The ISO base media file format is concerned with only the structure of the file containing the metadata. The format of the media-data files is constrained by the ISO base media file format or its derivative formats only in that the media-data in the media files must be formatted as specified in the ISO base media file format or its derivative formats.

Movie fragments can be used when recording content to ISO files in order to avoid losing data if a recording application crashes, runs out of disk, or some other incident happens. Without movie fragments, data loss may occur because the file format insists that all metadata (the Movie Box) be written in one contiguous area of the file. Furthermore, when recording a file, there may not be sufficient amount of RAM to buffer a Movie Box for the size of the storage available, and re-computing the contents of a Movie Box when the movie is closed is too slowly. Moreover, movie fragments can enable simultaneous recording and playback of a file using a regular ISO file parser. Finally, a smaller duration of initial buffering is required for progressive downloading (e.g., simultaneous reception and playback of a file, when movie fragments are used and the initial Movie Box is smaller in comparison to a file with the same media content but structured without movie fragments).

The movie fragment feature enables the splitting of the metadata that conventionally would reside in the moov box 220 to multiple pieces, each corresponding to a certain period of time for a track. Thus, the movie fragment feature enables interleaving of file metadata and media data. Consequently, the size of the moov box 220 can be limited and the use cases mentioned above be realized.

The media samples for the movie fragments reside in an mdat box 210, as usual, if they are in the same file as the moov box. For the meta data of the movie fragments, however, a moof box is provided. It comprises the information for a certain duration of playback time that would previously have been in the moov box 220. The moov box 220 still represents a valid movie on its own, but in addition, it comprises an mvex box indicating that movie fragments will follow in the same file. The movie fragments extend the presentation that is associated to the moov box in time.

The metadata that can be included in the moof box is limited to a subset of the metadata that can be included in a moov box 220 and is coded differently in some cases. Details of the boxes that can be included in a moof box can be found from the ISO base media file format specifications ISO/IEC International Standard 14496-12, Second Edition, 2005-04-01, including Amendments 1 and 2.

In addition to timed tracks, ISO files can contain any non-timed binary objects in a meta box, or “static” metadata. The meta box can reside at the top level of the file, within a movie box, and within a track box. At most one meta box may occur at each of the file level, movie level, or track level. The meta box is required to contain a ‘hdle’ box indicating the structure or format of the “meta” box contents. The meta box may contain any number of binary items that can be referred and each one of them can be associated with a file name.

In order to support more than one meta box at any level of the hierarchy (file, movie, or track), a meta box container box (“meco”) has been introduced in the ISO base media file format. The meta box container box can carry any number of additional meta boxes at any level of the hierarchy (file, move, or track). This allows, for example, the same meta-data to be presented in two different, alternative, meta-data systems. The meta box relation box (“mere”) enables describing how different meta boxes relate to each other (e.g., whether they contain exactly the same metadata, but described with different schemes, or if one represents a superset of another). It should be noted that within the latest “Technologies under Consideration” document for the ISO Base Media File Format (MPEG document N9378), it is no longer required that the binary items are located within a meta box. Rather, the binary items may reside anywhere in a file, e.g., in the mdat box, and also within a second file.

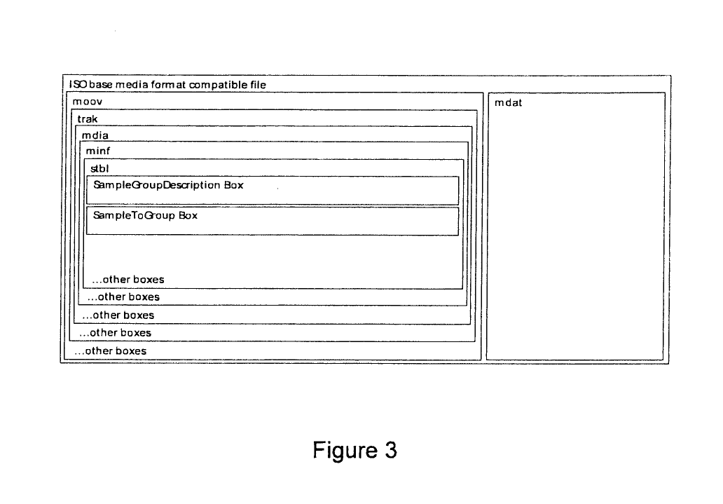

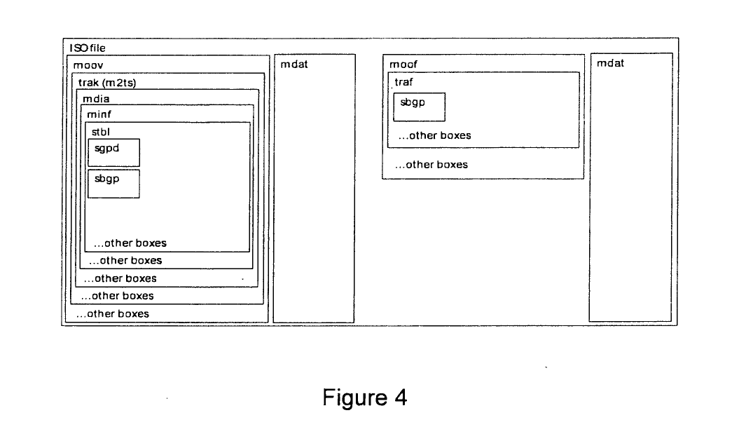

FIGS. 3 and 4 illustrate the use of sample grouping in boxes. A sample grouping in the ISO base media file format and its derivatives, such as the AVC file format and the SVC file format, is an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping has a type field to indicate the type of grouping. Sample groupings are represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These are distinguished by a type field used to indicate the type of grouping.

FIG. 3 provides a simplified box hierarchy indicating the nesting structure for the sample group boxes. The sample group boxes (SampleGroupDescription Box and SampleToGroup Box) reside within the sample table (stbl) box, which is enclosed in the media information (mint), media (mdia), and track (trak) boxes (in that order) within a movie (moov) box.

The SampleToGroup box is allowed to reside in a movie fragment. Hence, sample grouping can be done fragment by fragment. FIG. 4 illustrates an example of a file containing a movie fragment including a SampleToGroup box.

The Digital Video Broadcasting (DVB) organization is currently in the process of specifying the DVB file format. The primary purpose of defining the DVB file format is to ease content interoperability between implementations of DVB technologies, such as set-top boxes according to current (DVT-T, DVB-C, DVB-S) and future DVB standards, Internet Protocol (IP) television receivers, and mobile television receivers according to DVB-Handheld (DVB-H) and its future evolutions. The DVB file format facilitates the storage of all DVB content at the terminal side, and is intended to be an interchange format to ensure interoperability between compliant DVB devices. However, it should be noted that the DVB file format is not necessarily intended to be an internal storage format for DVB compatible devices, although the DVB file format should be able to handle various types of media and data that is being used by other DVB broadcast specifications. During the requirement collection phase of the DVB file format specification process, it was agreed that the DVB file format is to provide support for the following media formats: H.264; Society of Motion Picture and Television Engineers (SMPTE) 421M video codec (VC-1); Advanced Audio Coding (AAC), High Efficiency (HE)-AAC, HE-AACv2; Audio Code Number 3 (AC-3), AC-3+; Adaptive Multi Rate—Wideband plus (AMR—WB+); Timed Text as used by IP Datacast over DVB-H; Non-A/V content; Subtitling; Synchronized Auxiliary Data; Interactive applications; and Data.

Additionally, it should be noted that the DVB file format will allow for the exchange of recorded (e.g., read-only) media between devices from different manufacturers, where the DVB file format is to be derived from the ISO base media file format. Such an exchange of content can comprise, for example, the using of USB mass memories and/or similar read/write devices, and shared access to common disk storage on a home network, as well as other functionalities.

A key feature of the DVB file format is known as a reception hint track, which may be used when one or more packet streams of data are recorded according to the DVB file format.

Reception hint tracks indicate the order, reception timing, and contents of the received packets among other things. Players for the DVB file format may re-create the packet stream that was received based on the reception hint tracks and process the re-created packet stream as if it was newly received. Reception hint tracks have an identical structure compared to hint tracks for servers, as specified in the ISO base media file format. For example, reception hint tracks may be linked to the elementary stream tracks (i.e., media tracks) they carry, by track references of type ‘hint’. Each protocol for conveying media streams has its own reception hint sample format.

Servers using reception hint tracks as hints for sending of the received streams should handle the potential degradations of the received streams, such as transmission delay jitter and packet losses, gracefully and ensure that the constraints of the protocols and contained data formats are obeyed regardless of the potential degradations of the received streams.

The sample formats of reception hint tracks may enable the construction of packets by pulling data out of other tracks by reference. These other tracks may be hint tracks or media tracks. The exact form of these pointers is defined by the sample format for the protocol, but in general they consist of four pieces of information: a track reference index, a sample number, an offset, and a length. Some of these may be implicit for a particular protocol. These ‘pointers’ always point to the actual source of the data. If a hint track is built ‘on top’ of another hint track, then the second hint track must have direct references to the media track(s) used by the first where data from those media tracks is placed in the stream.

The conversion of received streams to media tracks allows existing players compliant with the ISO base media file format to process DVB files as long as the media formats are also supported. However, most media coding standards only specify the decoding of error-free streams, and consequently it should be ensured that the content in media tracks can be correctly decoded. Players for the DVB file format may utilize reception hint tracks for handling of degradations caused by the transmission, i.e., content that may not be correctly decoded is located only within reception hint tracks. The need for having a duplicate of the correct media samples in both a media track and a reception hint track can be avoided by including data from the media track by reference into the reception hint track.

Currently, two types of reception hint tracks are being specified: MPEG-2 transport stream (MPEG2-TS) and Real-Time Transport Protocol (RTP) reception hint tracks. Samples of an MPEG2-TS reception hint track contain MPEG2-TS packets or instructions to compose MPEG2-TS packets from references to media tracks. An MPEG-2 transport stream is a multiplex of audio and video program elementary streams and some metadata information. It may also contain several audiovisual programs. An RTP reception hint track represents one RTP stream, typically a single media type.

RTP is used for transmitting continuous media data, such as coded audio and video streams in networks based on the Internet Protocol (IP). The Real-time Transport Control Protocol (RTCP) is a companion of RTP, i.e. RTCP should be used to complement RTP always when the network and application infrastructure allow. RTP and RTCP are usually conveyed over the User Datagram Protocol (UDP), which, in turn, is conveyed over the Internet Protocol (IP). There are two versions of IP, IPv4 and IPv6, differing by the number of addressable endpoints among other things. RTCP is used to monitor the quality of service provided by the network and to convey information about the participants in an on-going session. RTP and RTCP are designed for sessions that range from one-to-one communication to large multicast groups of thousands of endpoints. In order to control the total bitrate caused by RTCP packets in a multiparty session, the transmission interval of RTCP packets transmitted by a single endpoint is proportional to the number of participants in the session. Each media coding format has a specific RTP payload format, which specifies how media data is structured in the payload of an RTP packet.

The metadata requirements for the DVB file format can be classified to four groups based on the type of the metadata: 1) sample-specific timing metadata, such as presentation timestamps; 2) indexes; 3) segmented metadata; and 4) user bookmarks (e.g., of favorite locations in the content).

An example of sample-specific timing metadata are presentation timestamps. There can be different timelines to indicate sample-specific timing metadata. Timelines need not cover the entire length of the recorded streams and timelines may be paused. For example, in an example scenario, a timeline A can be created in a final editing phase of a movie. Later, a service provider can insert commercials and provide a timeline B for those commercials. As a result, timeline A may be paused while the commercials are ongoing. Timelines can also be transmitted after the content itself. A mechanism for timeline sample carriage is specified in European Telecommunications Standards Institute (ETSI) Technical Specification (TS) 102 823, “Specification for the carriage of synchronised auxiliary data”. According to this specification, timeline samples are carried within the MPEG-2 program elementary streams (PES). A PES conveys an elementary audio or video bitstream, and hence timelines are accurately synchronized with audio and video frames.

Indexes may include, for example, video access points and trick mode support (e.g., fast forward/backward, slow-motion). Such operations may require, for example, indication of self-decodable pictures, decoding start points, and indications of reference and non-reference pictures.

In the case of segmented metadata, the DVB services may be described with a service guide according to a specific metadata schema, such as Broadcast Content Guide (BCG), TV-Anytime, or Electronic Service Guide (ESG) for IP datacasting (IPDC). The description may apply to a part of the stream only. Hence, the file may have several descriptive segments (e.g., a description about that specific segment of the program, such as “Holiday in Corsica near Cargese”) information.

In addition, the metadata and indexing structures of the DVB file format are required to be extensible and user-defined indexes are required to be supported.

Various techniques for performing indexing and implementing segmented metadata have been proposed, which include, for example, timed metadata tracks, sample groups, a DVBIndexTable, virtual media tracks, as well as sample events and sample properties. With regard to timed metadata tracks, one or more timed metadata tracks are created. A track can contain indexes of a particular type or can contain indexes of any type. In other words, the sample format would enable multiplexing of different index types. A track can also contain indexes of one program (e.g., of a multi-program transport stream) or many programs. Further still, a track can contain indexes of one media type or many media types.

As for sample groups, one sample grouping type can be dedicated for each index type, where the same number of sample group description indexes are included in the Sample Group Description Box as there are different values for a particular index type. A Sample to Group Box is used to associate samples to index values. The sample group approach can be used together with timed metadata tracks.

As to the DVBIndexTable, it is proposed that a new box, referred to as the DVBIndexTable box, is to be introduced in the Sample Table Box. The DVBIndexTable box contains a list of entries, wherein each entry is associated with a sample in a reception hint track through its sample number. Each entry further contains information about the accuracy of the index, which program of a multi-program MPEG-2 transport stream it concerns, which timestamp it corresponds to, and the value(s) of the index(es).

With regard to virtual media tracks, it has been proposed that virtual media tracks are to be composed from reception hint tracks by referencing the sample data of the reception hint tracks. Consequently, the indexing mechanisms for media tracks, such as the sync sample box could be indirectly used for the received media.

Lastly, with regard to the sample events and sample properties technique, it has been proposed to overcome two inherent shortcomings of sample groups (when they are used for indexing). First, a Sample to Group Box uses run-length coding to associate samples to group description indexes. In other words, the number of consecutive samples mapped to the same group description index is provided. Thus, in order to resolve group description indexes in terms of absolute sample numbers, a cumulative sum of consecutive sample counts is calculated. Such a calculation may be a computational burden for some implementations. Therefore, the proposed technique uses absolute sample numbers in the Sample to Event and Sample to Property Boxes (which correspond to the Sample to Group Box) rather than run-length coding. Second, the Sample Group Description Box resides in the Movie Box. Consequently, either the index values have to be known at the start of the recording (which may not be possible for all index types) or the Movie Box has to be constantly updated during recording to respond new index values. The updating of the Movie Box therefore, may require moving other boxes (such as the mdat box) within the file, which may be a slow file operation. The proposed Sample to Property Box includes a property value field, which practically carries the index value, and can reside in every movie fragment. Hence, the original Movie Box need not be updated due to new index values.

In accordance with the Convergence of Broadcast and Mobile Services (CBMS) group, DVB-CBMS work is ongoing to define a notification framework for IP Datacast over DVB-H. It is desired that the notification framework enables the delivery of notification messages, thus informing receivers and users about important events as soon as they happen. Notification messages can either be synchronized to some Audio/Visual (A/V) content or can be a stand-alone service. For example, synchronized notification messages can describe events that are related to some A/V service, e.g., requests for voting or contextual advertisements. Standalone notification services, can alternatively, for example, carry notification messages that are grouped by certain criteria but are not related to an A/V service. One example of a standalone notification service is a stock market ticker that delivers share prices.

Furthermore, notification services may be set as a default or can be user selected. Default notification messages can be of interest to all receivers and hence, can be expected to be received automatically, e.g., an emergency notification service. Alternatively, user-selected notification messages can be, for example, received only upon user selection. Depending upon the type of the notification service, the delivery of the notification messages may differ.

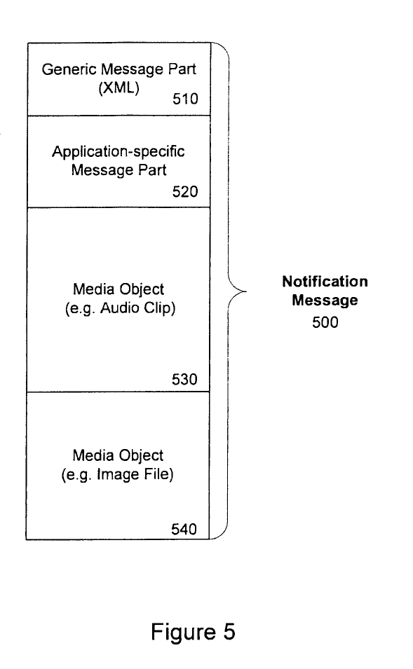

Transport mechanisms of notification messages are described in greater detail herein. A notification message, such as for example, that illustrated at 500 in FIG. 5 may be composed of multiple parts. A first part can be referred to as a generic message part 510, e.g., an Extensible Markup Language (XML) fragment that contains generic information about the notification message and is consumed by the notification framework. Another part can be referred to as an application-specific message part 520, e.g., a fragment (typically in XML format) that contains information describing the content of the notification message. Furthermore, the application-specific message part can be consumed by an application capable of processing the application-specific part of the notification message. Yet another part can be referred to as media objects, such as one or more audio file/clip 530 and one or more video file/clip 540 that constitute part of the notification message.

It should be noted that during the lifetime of a notification message, its parts and updates thereto may be delivered separately. Alternatively, some unchanged parts may be omitted completely. An example is a notification message that carries a command for receivers to fetch the other message parts, where some time later, an update of the notification message indicates that the previously fetched notification message is to be launched. All parts of a notification message may, however, be delivered as a single transport object by using the Multipart/Related Multipurpose Internet Mail Extensions (MIME) encapsulation. This encapsulation enables the aggregation of multiple notification messages in a single notification message, while still providing access to each single message part separately.

Two different transport protocols may be used for the delivery/transport of notification messages, e.g., RTP and FLUTE. FLUTE can be used for the delivery of un-synchronized and default notification messages, while RTP can be used for the delivery of synchronized, service-related notification messages. Alternatively, a combination of RTP and FLUTE can be used, where the bulky payload of a notification message (i.e., application-specific message part and media objects, if any) can be transported using FLUTE, while, e.g. only the generic message part of the notification message is delivered using RTP.

For RTP delivery, an RTP payload format header is defined to indicate the important information that enables the correct processing and extraction of the notification message. Moreover, the RTP payload format header also allows for the filtering of notification messages based on, e.g., their notification type. Additionally, the RTP payload format header provides the functionality for fragmentation and re-assembly of notification messages that exceed the maximum transmission unit (MTU) size.

A similar extension to the File Delivery Table (FDT) of FLUTE is defined to provide identification and fast access to information fields that are necessary for selection of notification messages. The notification message parts may then be encapsulated and carried as a single transport object or as separate transport objects. The generic notification message part can generally provide a list of the message parts that constitute the corresponding notification message. This will enable the notification framework to retrieve all the parts of a notification message and make them available to a consuming notification application. The references to the media objects, as well as the description of the way to use them, are typically provided by the application-specific message part. However, as the application-specific message part is not read by the notification framework, significant delays for reconstructing the notification message can occur if the notification framework is not aware of all the message parts to be retrieved.

The lifecycle of a notification object is generally as follows, where a notification object is created in a terminal as a response to notification messages associated with a particular Uniform Resource Identifier (URI). A terminal maintains a state machine for the notification object including the following states. “Absent” is the initial state of the object, and also the final state once the object has been (completely) removed from the system. This is the only state in which an object can last indefinitely. No timers are associated with this state, and therefore, a transition from this state to any other state implies loading the object.

“Loaded” is the state in which an object has been loaded (pre-fetched) into the system, but it has neither been activated nor has activation been programmed for some future time. It should be noted that the object will stay also in this state if an immediate activation action has been received but the activation has not yet been completely performed, e.g., while waiting for the application to start. The life time counter continuously decrements during this state, and the object is removed when the life time elapses.

“Waiting” refers to a state where, when the object has been loaded and an action has been received for activation at some future time, the object is waiting (and stays in this state until the activation is completed, e.g., the application is launched). In this waiting state, a launch_time parameter is continuously compared to some external time reference (e.g., the RTP presentation timestamps of an associated video stream). Conventionally, the object transitions to the active state when the intended launch_time has arrived or exceeded. This may be the case immediately, e.g., if the launch action was delayed during transmission. Moreover, a transition to other states may be triggered by appropriate actions. Again, the life time counter continuously decrements during this state, and the object is removed when the life time elapses.

“Active” refers to a state when the object has been loaded and becomes active. During this active state, both the active time counter and the life time counter decrement continuously. Elapsing of the active time triggers an automatic transition back to the loaded state (but the object stays present). Elapsing of the life time completely removes the object from the system (e.g., triggers a transition to the absent state).

Transitions between the notification object lifecycle states are triggered by actions as discussed above. These actions may be initiated by reception of notification messages (both explicit and implicit), or automatically triggered after a certain time. The different actions are discussed below together with proposed parameters passed to the object by these actions.

“Fetch” refers to an action where, as the object is fetched, its intended lifetime (until removal) needs to be determined (e.g., a default value). Lifetime can also be given as a relative value (from fetch to automatic removal), or as an absolute value (time of death in universal time). It should be noted that accuracy is not critical, as the provider should provide for enough margin of error. The intended active time shall also be determined as soon as the object is fetched. Although passing this parameter with the launch action would in principle be possible, this could waste bandwidth since the launch action needs to be repeated regularly during the active time. It should be noted that this refers to explicit fetches as well as implicit fetch (e.g., fetch actions triggered when a launch action for a not-yet-loaded object is received).

“Launch” refers to an action when an object is launched. When the object is launched, a maximum active time is defined. Since launch messages (triggers) are to be repeated in order to cope with non-perfect reception or a late channel switch, it should be possible to not repeat the active time in each launch message (i.e., the active time is known from the fetch) to save bandwidth. Resolution of the active time should be less than one second. The launch action may take effect immediately (e.g., as soon as possible (asap)), or when the launch time indicated in the action has arrived. Therefore, a comparison of the launch time to some time reference (depending on the transport mechanism, e.g., when the presentation time of the RTP time stamps exceeds the indicated launch time) is needed.

“Cancel” refers to an action that may be triggered through a specific notification message (or trigger), or when the deactivation is triggered by the expiration of a timer. For this reason, the cancel action in general does not carry further parameters (e.g., the life time will not be modified by a cancel action).

“Remove” is an action that may be triggered through a specific notification message (or trigger), where in most cases the object will be removed after a given time. This ends the object life, so no parameters are transmitted. “Update” refers to an action that can be useful to allow the updating of a life time or active time for existing objects. However, this is not necessary, as updates may be triggered directly by special update commands or by the reception of modified parameters for the fetch and launch actions.

To manage the automatic transition between the lifecycle states, each object needs the following timers: active time; and life time. The remaining active time is the intended time until automatic cancellation. It is initialized as a relative time from object activation to cancellation, with a resolution of milliseconds. Remaining life time refers to the intended time until automatic removal of the object. It is initialized from the “remove_time” parameter as a relative time at the time of object loading, with a resolution of seconds, where the initialisation may be done either from an absolute time value at the moment when the object is loaded, or from a relative time value.

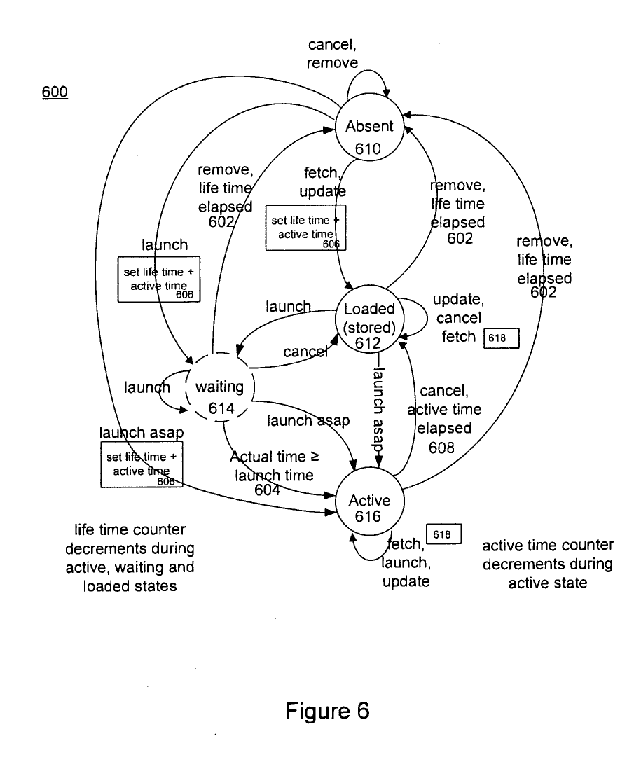

The lifecycle diagram (a.k.a. the state machine) for a notification object is presented in FIG. 6. Actions that reference “time,” e.g., “life time elapsed” 602, “actual time≧launch time” 604, “set life time+active time” 606, and “active time elapsed” 608 indicate whether a transition can be triggered by one of the timers. The “fetch” transition from an absent state 610 to a loaded (stored) state 612 and an “implicit fetch” (and launch) transition from the absent state 610 to a waiting state 614 also set both timers to their initial values (as described above). This is indicated with boxes 606 at the side of the transition. For “fetch” actions that do not create transitions (i.e., occurring in the loaded and active states 612 and 616, respectively), there are two possible behaviors: either both timers are set to their initial value, or there is no effect on the timers. It should be noted that these transitions are indicated with an empty box 618. Both choices lead to valid diagrams. A transient “waiting” state 614 indicates that a launch action has been received, but activation of the object is delayed until launch time. The object remains in a state until all of the conditions are fulfilled that allow transition to any other state, e.g., the initial state “absent” 610 will not be left before/until the (implicit) fetch action has been triggered and the object has been completely loaded. This convention allows a relatively simple lifecycle diagram without the addition of transitory states, such as “fetching object” or “launching application.”

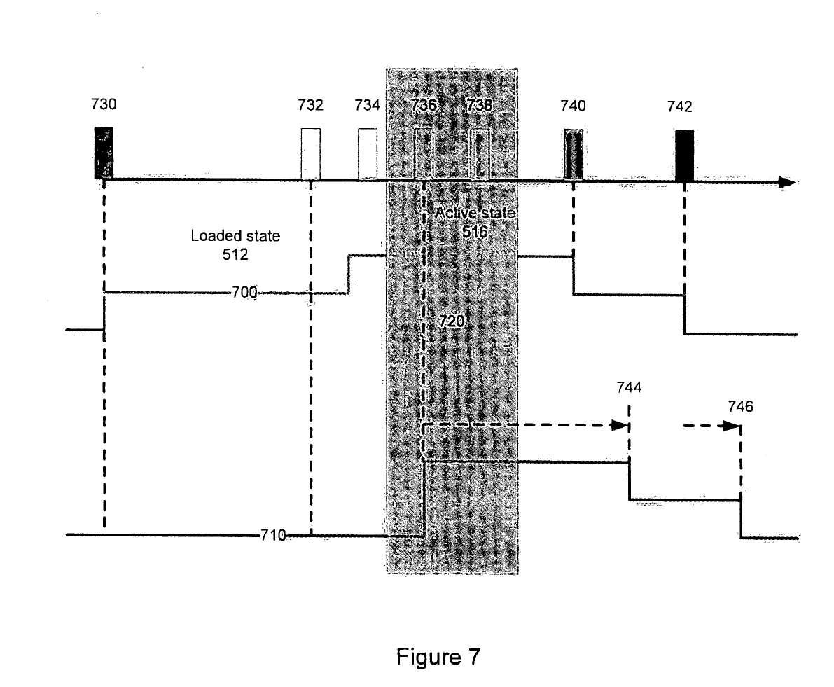

FIG. 7 illustrates simplified examples of notification object lifecycles with reference to (implicit or explicit) actions, and the resulting lifecycle of the notification object in two cases. The first case/notification object is represented by the upper line 700, e.g., one for a terminal which is in perfect reception conditions, while the lower line 710 is representative of the second case/notification object, e.g., for a terminal that receives notifications only during a limited time (shaded area 720).

In the first case, the notification object is loaded as soon as possible at fetch action 730, which, e.g., is implicit if the notification object is carrouseled. Upon receipt of the first “launch” notification 732 of a plurality of launch notifications 734-738, it is activated. The moment of activation may either be upon reception of the notification, or the notification may indicate the moment of activation, related to an accompanying audiovisual flow. The object is then deactivated and unloaded through explicit actions at 740 and 742, respectively. In the second case, the terminal may switch to a channel only when the object could already be activated. The terminal receives an activation message and loads at 736 (e.g., from a carrousel or through an interactive link) and activates the object immediately. At this time, sufficient information is present to get rid of the object even when communication is disrupted. Hence, deactivation of the object is triggered by a timer at some time after action 744 (after it has been active for a predetermined time.) Lastly, the notification object is removed when the lifetime counter has elapsed 746.

Notification messages, whether service-related or not, constitute an important component of a service offering to the user. The storage of notification messages is important for the user as it enables full-featured consumption of the service at some later point. It is also important to preserve the timeline of notification messages. However, notification messages may have a limited lifetime, e.g., voting requests may only be valid during a related TV program. It is then up to the application to filter out those messages during delayed playback.

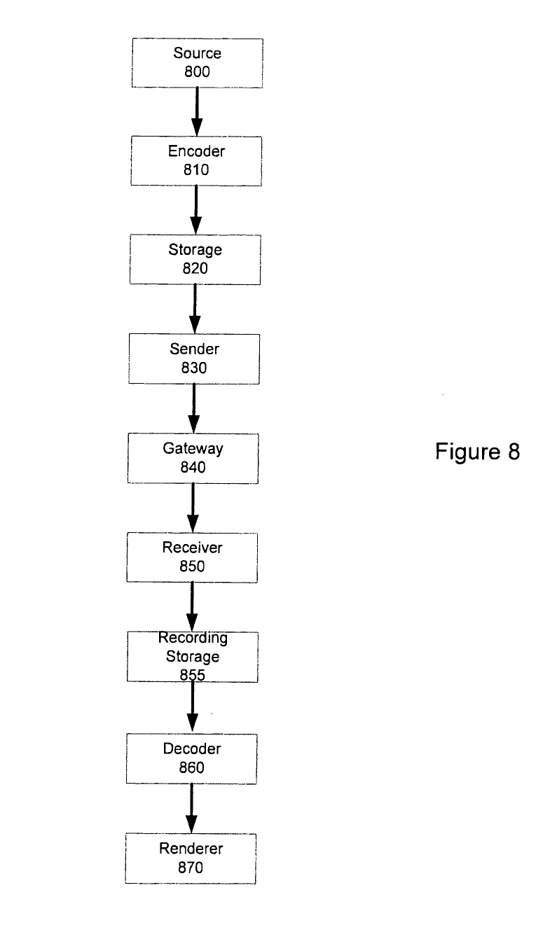

FIG. 8 is a graphical representation of a generic multimedia communication system within which various embodiments of the present invention may be implemented. As shown in FIG. 8, a data source 800 provides a source signal in an analog, uncompressed digital, or compressed digital format, or any combination of these formats. An encoder 810 encodes the source signal into a coded media bitstream. It should be noted that a bitstream to be decoded can be received directly or indirectly from a remote device located within virtually any type of network. Additionally, the bitstream can be received from local hardware or software. The encoder 810 may be capable of encoding more than one media type, such as audio and video, or more than one encoder 810 may be required to code different media types of the source signal. The encoder 810 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 8 only one encoder 810 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 820. The storage 820 may comprise any type of mass memory to store the coded media bitstream. The format of the coded media bitstream in the storage 820 may be an elementary self-contained bitstream format, or one or more coded media bitstreams may be encapsulated into a container file. Some systems operate “live”, i.e. omit storage and transfer coded media bitstream from the encoder 810 directly to the sender 830. The coded media bitstream is then transferred to the sender 830, also referred to as the server, on a need basis. The format used in the transmission may be an elementary self-contained bitstream format, a packet stream format, or one or more coded media bitstreams may be encapsulated into a container file. The encoder 810, the storage 820, and the server 830 may reside in the same physical device or they may be included in separate devices. The encoder 810 and server 830 may operate with live real-time content, in which case the coded media bitstream is typically not stored permanently, but rather buffered for small periods of time in the content encoder 810 and/or in the server 830 to smooth out variations in processing delay, transfer delay, and coded media bitrate.

The server 830 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 830 encapsulates the coded media bitstream into packets. For example, when RTP is used, the server 830 encapsulates the coded media bitstream into RTP packets according to an RTP payload format. Typically, each media type has a dedicated RTP payload format. It should be again noted that a system may contain more than one server 830, but for the sake of simplicity, the following description only considers one server 830.

The server 830 may or may not be connected to a gateway 840 through a communication network. The gateway 840 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 840 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 840 is called an RTP mixer or an RTP translator and typically acts as an endpoint of an RTP connection.

The system includes one or more receivers 850, typically capable of receiving, de-modulating, and de-capsulating the transmitted signal into a coded media bitstream. The coded media bitstream is transferred to a recording storage 855. The recording storage 855 may comprise any type of mass memory to store the coded media bitstream. The recording storage 855 may alternatively or additively comprise computation memory, such as random access memory. The format of the coded media bitstream in the recording storage 855 may be an elementary self-contained bitstream format, or one or more coded media bitstreams may be encapsulated into a container file. If there are many coded media bitstreams, such as an audio stream and a video stream, associated with each other, a container file is typically used and the receiver 850 comprises or is attached to a container file generator producing a container file from input streams. Some systems operate “live,” i.e. omit the recording storage 855 and transfer coded media bitstream from the receiver 850 directly to the decoder 860. In some systems, only the most recent part of the recorded stream, e.g., the most recent 10-minute excerption of the recorded stream, is maintained in the recording storage 855, while any earlier recorded data is discarded from the recording storage 855.

The coded media bitstream is transferred from the recording storage 855 to the decoder 860. If there are many coded media bitstreams, such as an audio stream and a video stream, associated with each other and encapsulated into a container file, a file parser (not shown in the figure) is used to decapsulate each coded media bitstream from the container file. The recording storage 855 or a decoder 860 may comprise the file parser, or the file parser is attached to either recording storage 855 or the decoder 860.

The codec media bitstream is typically processed further by a decoder 860, whose output is one or more uncompressed media streams. Finally, a renderer 870 may reproduce the uncompressed media streams with a loudspeaker or a display, for example. The receiver 850, recording storage 855, decoder 860, and renderer 870 may reside in the same physical device or they may be included in separate devices.

Various embodiments provide systems and methods for storing notification messages in an ISO base media file. Different transport cases when notification messages are to be stored are addressed separately herein. It should be noted that other transport cases to which various embodiments may be applied are contemplated herein.

In a first case of RTP-only transport, an RTP reception hint track is used to store notification messages. In a second case of RTP+FLUTE transport, an RTP reception hint track is used to store the RTP packets including the generic part of notification message and preserve synchronization to other tracks. The notification objects referenced and retrieved over the FLUTE session are recovered and stored as a static metadata item referred by a meta box. The location of the item can be within a meta box or a media data box of the file or within an external file. In a third case of FLUTE-only transport, a FLUTE reception hint track is used to preserve reception timing of notification messages. Alternatively, the messages retrieved over the FLUTE session are recovered and stored as a static metadata item referred by a meta box. The static metadata items are referred to by a timed metadata track preserving the reception timing of the notification messages. Alternatively, the messages retrieved over the FLUTE session are recovered and stored as samples of a timed metadata track that preserves the reception timing of the notification messages. Therefore, a mechanism to link the notification messages or message parts delivered over RTP to the other notification message parts delivered over FLUTE is provided herein.

As described above, a notification object may not be activated at the time of the receipt of the respective notification message, but may rather be scheduled to be activated at a particular time or triggered to be active by a later notification message. Hence, it is not a straightforward process to conclude which notification objects are active at a particular point in media playback timeline. For example, when accessing a file at an arbitrary playback position, the reception hint track for notification messages should be traversed backwards to determine all of the notification objects active at and subsequent to the point of random access. Similarly, when editing a file, such as when removing samples from the beginning of the file or concatenating two files, scheduled activation of notification objects requires careful investigation of the dependencies between samples of different tracks. A mechanism to pre-compute the lifecycle state periods of notification objects is therefore provided herein. The mechanism is based on the indexing mechanism of the DVB file format.

In one embodiment, a notification message part delivered over FLUTE is stored as an item, e.g., in a media data (“mdat”) box. The item is identified by its item ID as well as a URI and a version number. The URI is used by the notification framework to identify the parts of a notification message. The version number is used to differentiate between different versions of a part of a notification message. Notification message parts may be updated during the lifetime of a notification message. In order to enable proper storage of notification messages, each message part is assigned with a version.

Currently in the ISO Base Media File Format, an item is described by the following ItemInfoEntry box:

```
aligned(8) class ItemInfoEntry
extends FullBox(‘infe’, version = 0, 0) {
      unsigned int(16) item_ID;
      unsigned int(16) item_protection_index
      string item_name;
      string content_type;
      string content_encoding; //optional
}
```

In the “Technologies under Consideration for the ISO Base Media File Format” document, an item is described by a modified version of ItemInfoEntry box (referred to as ItemInfoEntry2) as follows:

| aligned(8) class ItemInfoEntry2 | | |
|---|---|---|
| extends FullBox(‘inf2’, version, 0) { | | |
| unsigned int(16) | item_ID; | |
| unsigned int(16) | item_protection_index; | |
| unsigned int(32) | item_type; | // 4CC |

| | |
|---|---|
| string | item_name; |

| | |
|---|---|
| if (item_type==’mime’) { | |
| string content_type; | |
| string content_encoding; | //optional |
| } | |
| } | |

In another embodiment, the information about an item is extended to indicate the reference to the RTP session (using a track ID) and the version number of the part of the notification message included in the item. In other words, the ItemInfoEntry or ItemInfoEntry2 structures described above are appended with related_track_ID and version_num fields. The presence of these additional fields may be conditional and indicated by a flag in the ItemInfoEntry or ItemInfoEntry2 structures. The reference to the RTP session enables unique association of items (which contain notification message parts), with the notification message parts carried using RTP. This is especially useful if the URIs of the items are not globally unique but rather unique within the scope of a notification session or FLUTE session that carries them. The additional fields for the extended item info entry may be defined as follows:

unsigned int(32) related_track_ID; unsigned int(16) version_num;

In yet another embodiment, ItemInfoEntry2 is modified to contain the URI of the notification message in addition to the track ID of the related track and the version number of the notification message part. The modified syntax of ItemInfoEntry2 is as follows:

| aligned(8) class ItemInfoEntry2 | | |
|---|---|---|
| extends FullBox(‘inf2’, version, 0) { | | |
| unsigned int(16) | item_ID; | |
| unsigned int(16) | item_protection_index; | |
| unsigned int(32) | item_type; | // 4CC |
| string | item_name; | |

| if (item_type==’mime’) { | |
|---|---|
| string content_type; | |
| string content_encoding; | //optional |
| } | |
| if (item_type==’ntfc’) { | |
| unsigned int(32) related_track_ID; | |
| unsigned int(16) version_num; | |
| string uri; | |
| } | |

In still another embodiment, ItemInfoEntry2 is specified as above, but item_name is considered to contain the URI for the item, and therefore, no URI field is included. It should be noted, however, that a metadata item may contain fragments, each associated with its own URI. Hence, item_name in the Item Info Entry for the Item Information Box is not always sufficient for representing all of the URIs present in the item. Rather, item_name can be associated with any symbolic name for the item, such as a file name rather than a URI.

In another embodiment, a new box, referred to as a URI-Version-Item Mapping Box, is specified to include item_ID, URI, related_track_ID, and version_num fields, while ItemInfoEntry and ItemInfoEntry2 remain unchanged. The URI-Version-Item Mapping Box can occur at the file level, i.e., not contained in any other box. Alternatively, the URI-Version-Item Mapping Box can occur at the movie level, i.e., contained in the Movie Box. Generally, there is only one URI-Version-Item Mapping Box present in a file. If more than one URI-Version-Item Mapping Boxes exist in a file, their respective information must not contradict. That is, the same pair of item ID and related track ID is always associated with for a particular pair of URI and version number regardless of which URI-Version-Item Mapping Box includes them. The URI-Version-Item Mapping Box can be specified as follows:

```
aligned(8) class uriVersionItemMappingBox
          extends FullBox(‘uvim’, version, flags) {
          unsigned int(32) entry_count;
          for (i=1; i<=entry_count; i++) {
              unsigned int(16)  item_ID;
              string uri;
              if (flags & 1)
                  unsigned int(16) version_num;
              if (flags & 2)
                  unsigned int(32) related_track_ID;
          }
}
```

The parameter item_ID specifies the item under consideration. The URI field contains a URI present in the specified item. It should be noted that in a general case, there may be multiple

URIs for a single item, each for a different section of the item. The parameter version_num specifies the version of the item pointed by the URI. If version_num is not present, the version number is not relevant for the item pointed by the URI. The parameter related_track_ID is given for notification message items where the generic message part is conveyed over RTP. The related_track_ID parameter usually points to an RIP reception hint track representing the RTP stream for the generic message parts of notification messages. The related_track_ID parameter may also point to a timed metadata track containing index events for state changes of notification objects. Details of both RTP reception hint track and timed metadata track for notification object state changes can thus be subsequently found.

One example of a receiver operation storing incoming streams to a file is as follows, where the receiver receives the audio and video streams that a user has selected. The streams are stored as RTP reception hint tracks. In addition, the receiver receives any synchronized notification messages that are associated with the recorded RTP streams (according to the information in the ESG). The RTP packets including the generic part of the synchronized notification messages are recorded as RTP reception hint tracks. The receiver may filter the notification messages and store only the desired ones to the file. The receiver also receives those FLUTE sessions that contain application-specific parts and media objects for the recorded RTP streams. These objects are retrieved according to the FLUTE protocol (including potential forward error correction (FEC) decoding to correct transmission errors). The application-specific part and media objects are stored as metadata items in the file. For each new item, the receiver updates the item information box with a new item information entry linking the item ID, URI, version number, and the track containing the generic parts of notification messages with each other. Alternatively, the receiver may update the URI-Version-Item Mapping Box.

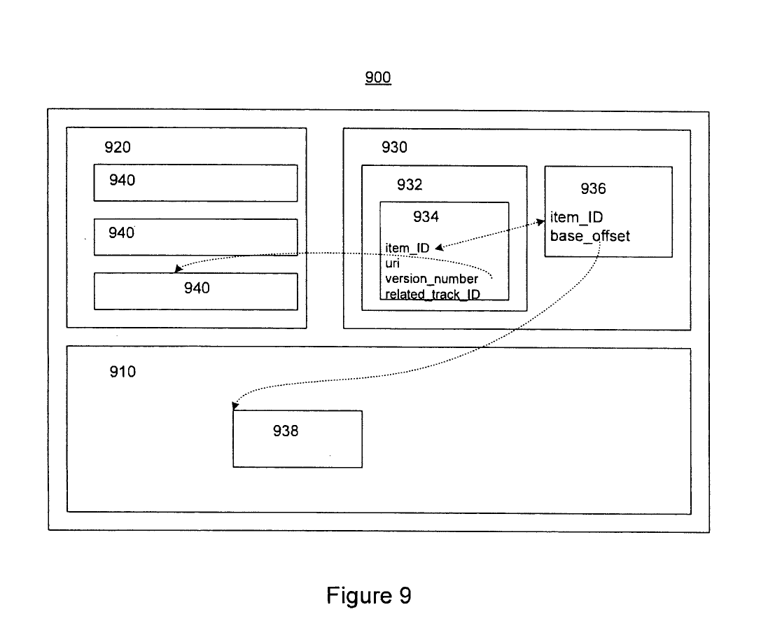

One example of a parser operation for parsing incoming files including notifications stored according to the invention is described in FIG. 9. FIG. 9 illustrates the linking of notification messages parts delivered over RTP and FLUTE within a ISO Base Media File Format file 900. While parsing the RTP reception hint track 940 of a notification service, a receiver identifies a reference (e.g., URI) to an object from the generic message part of the same notification message. The receiver parses the item information (“iinr) box 932 of the “meta” box 930 to extract the item_ID of the object from the “inf2” entry 934 for which the uri of the “inf2” entry matches the URI of the object. In accordance with other embodiments, the item_name and version_num fields of “inf2” entry 934 can be used or the URI-Version-Item Mapping Box can be used to get the item_ID corresponding to item 938 containing the application-specific part and media objects of the notification message. Afterwards, a lookup in the “iloc” box 936 is performed to find out the location of the object within the file, e.g., in an “mdat” box 910.

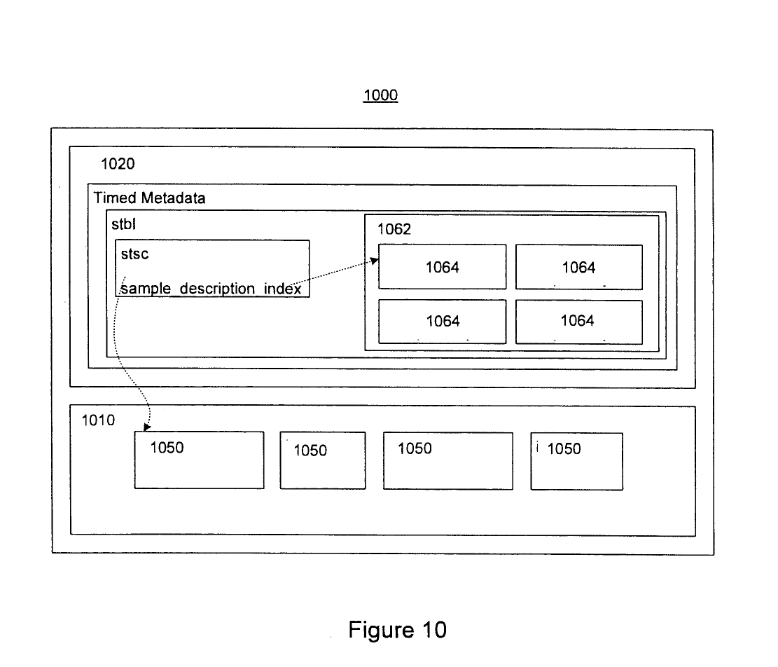

In an embodiment, notification messages delivered over FLUTE are stored as samples of a timed metadata track. The links between the different information fields that describe an object of a FLUTE session are illustrated in FIG. 10 showing a file 1000 containing a moov box 920 and a “mdat” box 1010. Each transport object delivered over FLUTE is stored as a separate sample 1050 in the “mdat” box 1010. A sample includes the transport object delivered over FLUTE and is described by a sample entry 1064 in the sample description box “stsd” 1062 for the metadata track. A new sample entry format is defined extending the MetaDataSampleEntry. The ObjectMetaDataSampleEntry carries required information about the transport object. The ObjectSampleEntry may be defined as follows.

```
class ObjectMetaDataSampleEntry( ) extends MetaDataSampleEntry
    (‘tome’) { string content_encoding; // optional
    string  mime_format;
}
```

A content_encoding string specifies which content encoding algorithm is used in objects referring to this sample entry. Examples of content encoding algorithms include, but are not limited to ZLIB (Deutsch, P. and J-L. Gailly, “ZLIB Compressed Data Format Specification version 3.3”, Internet Engineering Task Force RFC 1950, May 1996.), DEFLATE (Deutsch, P., “DEFLATE Compressed Data Format Specification version 1.3”, Internet Engineering Task Force RFC 1951, May 1996.), and GZIP (Deutsch, P., “GZIP file format specification version 4.3”, Internet Engineering Task Force RFC 1952, May 1996.). content-type specifies the MIME type of the objects referring to this sample entry.

A sample format for samples 1050 referring to the ObjectMetaDataSampleEntry can be specified as follows.

```
class ObjectSample( ) {
    string content_location;
    unsigned int(16) version_number;
    unsigned int(8) transport_object[ ]; // length determined by
    sample size
}
```

Here, the content_location string is a null-terminated string of the URI of the transport object. The version_number carries the version number of the transport object. The byte array transport_object is a transport object carried over FLUTE. The byte array contains the remaining bytes of the sample as determined by the Sample Size Box or the Compact Sample Size Box, whichever is in use for this track.

Certain benefits of the above approach are that processing for the reader is made substantilally easier as it de-capsulates the FLUTE packets to extract the files in a FLUTE session. Moreover, space is saved by removing redundancy due to file carouselling or FEC data in FLUTE. It should be noted that the decoding time associated with a transport object may indicate the time of reception of first packet or last packet of the transport object. Alternatively it can show the expiry time of the FDT instance that declares the file.

A notification object lifecycle can be “pre-computed”. That is, a receiver or a file editor processing streams including a notification RTP stream or a file including a notification RTP reception hint track, respectively, can indicate the state of a notification object with any indexing mechanism available for DVB files. In particular, the timed activation, deactivation (a.k.a. cancellation), and removal actions can be represented with index events occurring at the time of the action. Creation of the notification indexes can happen at the time of recording or as an off-line operation when processing a recorded file.

An example of an index format is as follows:

```
aligned(8) class DVBNotificationIndex extends DVBIndexBox(‘idni‘) {
        unsigned int(6) reserved;
        unsigned int(2) state;
        unsigned int(16)  item_ID;
}
```

The parameter “state” equaling 0 indicates that the notification object is absent. If the state is equal to 1, it is indicative that the notification object is loaded. If the state is equal to 2, it is indicatative that the notification object is waiting. If the state is equal to 3, it is indicative that the notification object is active. The item_ID indicates the metadata item containing the generic part of the referred notification object.

Another example of an index format is as follows:

```
aligned(8) class DVBNotificationIndex extends DVBIndexBox(‘idni‘) {
        unsigned int(6) reserved;
        unsigned int(2) state;
        unsigned int(16)  version_num;
        string  uri;
}
```

In this example, state is defined as above. The URI field provides the URI of the generic part of the referred notification object, while version_num provides the version number of the notification object.

One example of a receiver operation storing incoming streams to a file is as follows. The receiver receives the audio and video streams that the user has selected. The streams are stored as RTP reception hint tracks. In addition, the receiver receives any synchronized notification messages that are associated with the recorded RTP streams (according to the information in the ESG). The receiver may filter the notification messages and process only the desired ones (as described below). The receiver maintains a lifecycle model for each processed notification object according to the information provided in the RTP packets containing the generic parts of the processed notification messages. The generic part of any processed notification object is stored as a metadata item in the file. The receiver also receives those FLUTE sessions that contain application-specific parts and media objects for the processed notification messages. These objects are retrieved according to the FLUTE protocol (including potential FEC decoding to correct transmission errors).

The application-specific part and media objects are stored as metadata items in the file. For each new item, the receiver updates the item information box with a new item information entry linking the item ID, URI, version number, and the track containing the generic parts of notification messages with each other. The receiver also creates indexes, such as samples in a timed metadata track, to represent state changes of a notification object. In particular, the receiver creates an index event whenever a notification message packet triggers a state change immediately, and when a state change is triggered by a timer, i.e. when the actual time has reached the launch time of a notification object, when the active time of a notification object has elapsed, or when a life time of a notification object has elapsed.

One example of file processing is described herein as well. The process takes as an input a file including an RTP reception hint track for the generic parts of notification messages and metadata items for application-specific parts and media objects of notification messages. (A receiver creating such a file was described above.) The process outputs a file where the states of notification objects have been pre-computed. The process essentially copies any media tracks and reception hint tracks for media streams and the related file metadata from the input file to the output file. Additionally, the process maintains a lifecycle model for each notification object according to the information provided in the RTP packets containing the generic parts of the processed notification messages. Furthermore, the process stores the generic part of any processed notification object as a metadata item in the file.

For each new item, the process updates the item information box with a new item information entry linking the item ID, URI, and version number of notification messages with each other. The process also creates indexes, such as samples in a timed metadata track, to represent state changes of a notification object. In particular, the process creates an index event whenever a notification message packet triggers a state change immediately, and when a state change is triggered by a timer, e.g., when the actual time has reached the launch time of a notification object, when the active time of a notification object has elapsed, or when a life time of a notification object has elapsed. Finally, it is noted that the RTP reception hint track containing the notification messages need not be copied from the input file to the output file.

In accordance with various embodiments, other uses for the URI-Version-Item Mapping Box can be effectuated. It should be noted that the URI-Version-Item Mapping Box is not only capable of linking different parts of notification messages with each other, but can also be used for, e.g., locating parts of ESG. URI is generally used as an identifier for associating descriptive segmented metadata to reception hint samples or media samples. In order to resolve the contents of the descriptive metadata, a file parser has to resolve which item the URI points to. Without a URI-Version-Item Mapping Box, the file parser may have to traverse through and parse all the items stored in the file. If the URI-Version-Item Mapping Box is available, the file parser locates for the pointed URI in the URI-Version-Item Mapping Box and obtains the respective item ID. Based on the item ID, the parser then uses the Item Location Box to find the respective item within the file.

Yet another use for the URI-Version-Item Mapping Box is to refer to a content item from an index event in the file format representing the TVA_id descriptor specified in ETSI TS 102 323. TVA_id descriptors can be embedded in, e.g., an MPEG-2 transport stream. A TVA_id descriptor indicates the running status for one or more content items. The running status can be one of the following: not yet running, starts shortly, paused, running, cancelled.

Additionally, the TVA_id descriptor identifies the content item with TVA_id. The association of an item of content with a particular TVA_id is made within a DVB locator as carried in the Content Referencing Information (CRI) or within TVA metadata. The TVA_id serves as a local identifier of a content item within an MPEG-2 transport stream for a certain period of time. Therefore, a URI can be used instead of a TVA_id for referencing to a content item within a recorded file to avoid reuse of the same TVA_id values—which may happen particularly if two recorded files are concatenated. A receiver stores the metadata related to a used value of TVA_id as a metadata item in a file and associates a URI with the content item. The associated URI may be e.g. a Content Reference Identifier (CRID), specified in ETSI TS 102 822-4. The receiver further creates a URI-Version-Item Mapping Box, where an item ID for the metadata item and the associated URI are coupled. For a received TVA_id descriptor, the receiver creates a respective index event, including the running status and an URI of the content item. Instead of the URI, the index event may also contain an entry index in the URI-Version-Item Mapping Box that corresponds to the URI or each entry in the URI-Version-Item Mapping Box may have its own unique identifier with the box that can be used in the index event for referencing. Moreover, instead of a URI, any other generic identifier, such as TVA_id, may be used, and a respective mapping box between the generic identifier and item_ID is provided in the file.

The index event for indicating the running status can be specified as follows:

```
aligned(8) class DVBIDIndex extends DVBIndexBox(‘didi‘) {
        unsigned int(5) reserved;
        unsigned int(3) running_status;
        unsigned int(32)  entry_index;
}
```

As described above, the URI-Version-Item Mapping Box can be used for various purposes and the namespace for the URI may differ: In one embodiment, more than one URI-Version-Item Mapping Box is allowed, each having a different namespace or purpose, indicated in the box. The URI-Version-Item Mapping Box of this embodiment can be specified as follows:

```
aligned(8) class uriVersionItemMappingBox
          extends FullBox(‘uvim’, version, flags) {
          unsigned int(32) namespace_type;
          if (namespace_type == ‘ntfc’) // IPDC notification message
              unsigned int(32) related_track_ID;
          else if (namespace_type == ‘esg ‘) // ESG
              unsigned int(16) esg_info_item_id;
          unsigned int(32) entry_count;
          for (i=1; i<=entry_count; i++) {
              unsigned int(16)  item_ID;
              string uri;
              if (flags & 1)
                  unsigned int(16) version_num;
          }
}
```

The namespace_type parameter specifies which fields are included in the box to uniquely identify the namespace for URIs that are used. The syntax shows two namespace types to exemplify this embodiment but can be generalized to include any number of namespace types. The related_track_ID parameter specifies the track containing the generic parts of the notification messages whose URIs are included in this box. esg_info_item_id points to the metadata item that contains the instantiation information for ESG, which also specifies the namespace for URIs of ESG fragments.

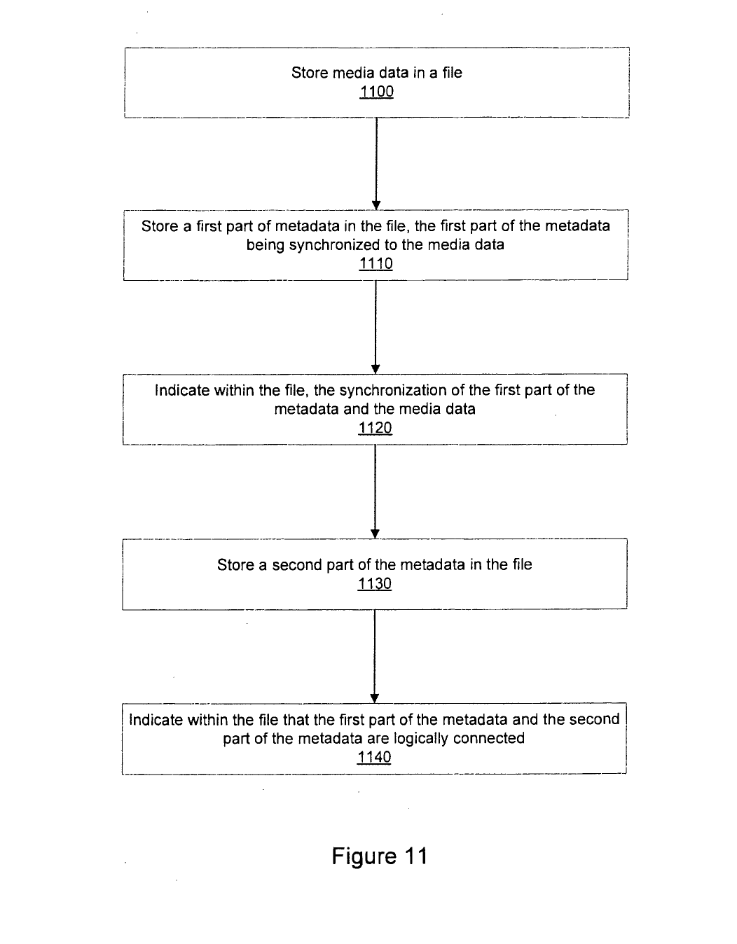

FIG. 11 is a flowchart illustrating processes performed in accordance with various embodiments for storing incoming bitstreams to a file. It should be noted that various embodiments, as described above, may perform more or less processes than those included in FIG. 11. Additionally, various embodiments may be implemented, for example, at a receiver that receives audio/video streams that a user has selected. At 1100, media data, e.g., audio and video frames, is stored in a file, such as an ISO base media file. The media data is synchronized with at least a first part of metadata, e.g., a notification service/message, where the first part of the metadata can comprise an RTP packet payload that includes a generic part of the notification message. At 1110, the first part of the metadata is also stored in the file. At 1120, the synchronization between the first part of the metadata and the media data is indicated within the file. At 1130, a second part of the metadata is stored within the file, where the second part can comprise, e.g., an application-specific part and media objects (if present) of the notification message. Lastly at 1140, the logical connection between the first and second parts of the metadata is indicated in the file.

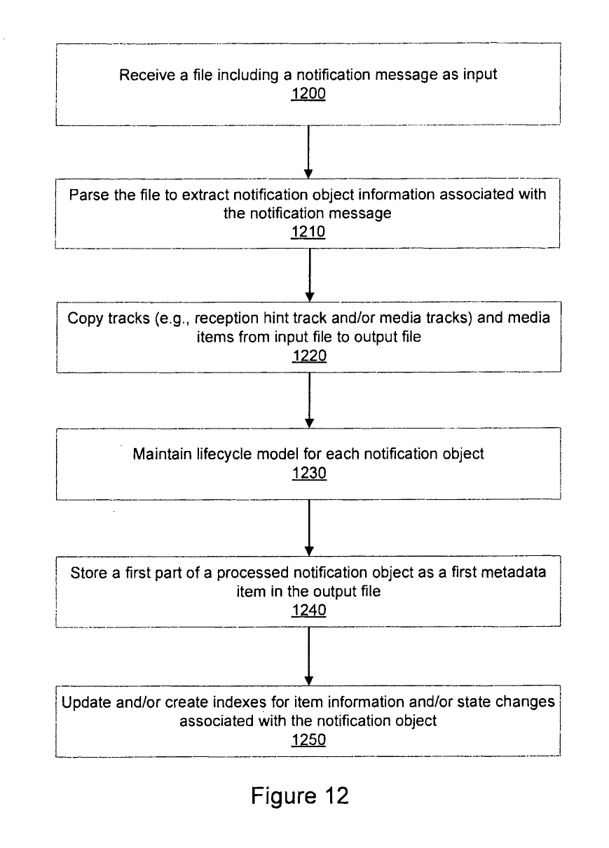

FIG. 12 illustrates a process of parsing/file processing incoming files in accordance with various embodiments. It should be noted that various embodiments are not necessarily limited to performing these processes shown, as more or less processes may be performed to effectuate various embodiments. At 1200, a receiver may receive a file including a notification message as an input. At 1210, the file is parsed to extract notification object information associated with the notification message. For example, the file may include an RTP reception hint track for generic parts of the notification message and metadata items for application-specific parts and media objects of the notification message as described above. Additionally, the parsing of the file can include, e.g., identifying a URI to a notification object from the generic message part and parsing item information to extract ID information corresponding to the URI of the notification object. At 1220, the various tracks, e.g., the RTP reception hint track and media tracks, along with media items from the input file are copied from the input file to the output file. At 1230, a notification lifecycle model for each notification object is maintained, and at least a first part of a processed notification object is stored in the output file as a first metadata item at 1240. Lastly, at 1250, various embodiments create indexes stored into the output file to reflect notification object state changes and update item information to link URIs and metadata items of the output file, which are associated with the notification object. It should be noted that more than one notification message and/or object may be processed.

Various embodiments described herein enable the linking of notification message parts delivered over RTP with other parts of a notification message carried over FLUTE (or some other protocol, e.g., Hypertext Transfer Protocol (HTTP)). Implementations of various embodiments can be generic and allows objects delivered out-of-band to be referenced from media and hint tracks. Moreover, various embodiments provide methods for efficient storage of a received FLUTE session. By extracting and storing the transport objects of a FLUTE session, both redundancy and retrieval time are reduced, while still preserving the timeline. Additionally still, various embodiments facilitate reproduction of the lifecycle of notification objects into the file without timers required in the parsing of the file. Such a feature of various embodiments simplifies operations such as random access and file editing.

Communication devices incorporating and implementing various embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

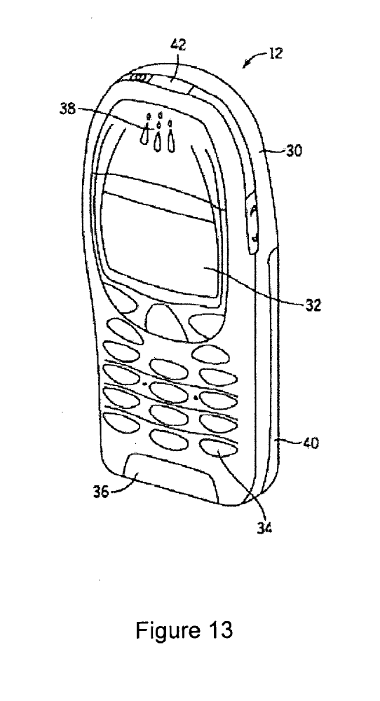

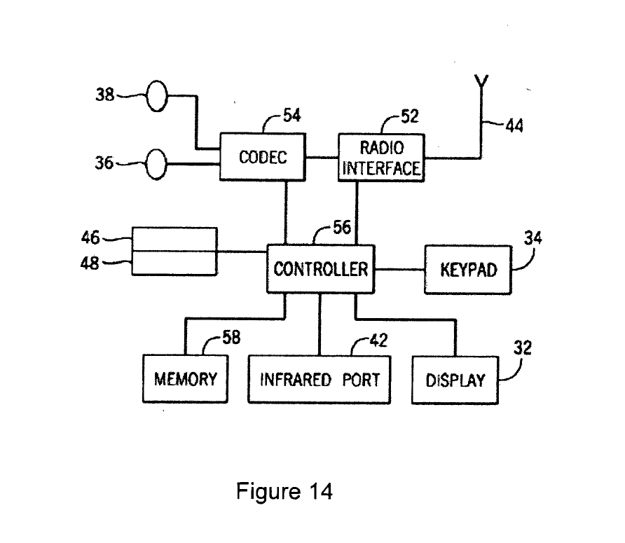

FIGS. 13 and 14 show one representative electronic device 12 within which the present invention may be implemented. It should be understood, however, that the present invention is not intended to be limited to one particular type of electronic device 12. The electronic device 12 of FIGS. 13 and 14 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1-49. (canceled)

50. A method of organizing media data and metadata, comprising:
storing the media data in a file;
storing a first part of the metadata in the file, the first part of the metadata being synchronized with the media data and comprises a state of a notification object lifecycle model, and;
indicating in the file the synchronization of the first part of the metadata relative to the media data;
storing a second part of the metadata in the file, wherein the second part of the metadata comprises a notification message; and
indicating in the file that the first part of the metadata and the second part of the metadata are logically connected.

51. The method of claim 50, wherein the first part of the metadata comprises a real time transport protocol packet payload including a generic part of a notification message, and wherein the second part of the metadata comprises at least one of an application-specific part of the notification message and a media object of the notification message.

52. The method of claim 50, wherein:
a file-specific identifier is associated with the second part of the metadata;
a generic identifier is associated with the file-specific identifier, the generic identifier being configured to indicate in the file that the first part of the metadata and the second part of the metadata are logically connected; and
the association of the generic identifier and the file-specific identifier is indicated in the file.

53. The method of claim 52, wherein the generic identifier is a universal resource identifier.

54. A computer program product, embodied in a computer-readable medium, comprising computer code for performing the process of any of claims 50.

55. An apparatus, comprising:
a processor configured to:
store media data in a file organizing the media data and metadata;
store a first part of the metadata in the file, the first part of the metadata being synchronized with the media data;
indicate in the file the synchronization of the first part of the metadata relative to the media data and comprises a state of a notification object lifecycle model, and;
store a second part of the metadata in the file, wherein the second part of the metadata comprises a notification message; and
indicate in the file that the first part of the metadata and the second part of the metadata are logically connected.

56. The apparatus of claim 55, wherein the first part of the metadata comprises a real time transport protocol packet payload including a generic part of a notification message, and wherein the second part of the metadata comprises at least one of an application-specific part of the notification message and a media object of the notification message

57. The apparatus of claim 55, wherein:
a file-specific identifier is associated with the second part of the metadata;
a generic identifier is associated with the file-specific identifier, the generic identifier being configured to indicate in the file that the first part of the metadata and the second part of the metadata are logically connected; and
the association of the generic identifier and the file-specific identifier is indicated in the file.

58. The apparatus of claim 57, wherein the generic identifier is a universal resource identifier.

59. A method of processing an input file including at least one notification message, comprising:
performing at least one of:
parsing the input file to extract information corresponding to a notification object of the at least one notification message; and
producing an output file, wherein states of the notification object have been pre-computed.

60. The method of claim 59, wherein the parsing of the file further comprises parsing a real time transport protocol reception hint track to identify a reference to the notification object from a generic message part of the at least one notification message.

61. The method of claim 59, further comprising: maintaining a notification object lifecycle model for the notification object.

62. The method of claim 61, further comprising: creating at least one index representative of changes to the states of the notification object.

63. A computer program product, embodied in a computer-readable medium, comprising computer code for performing the process of any of claims 59.

64. An apparatus, comprising:
a processor configured to perform at least one of:
parse an input file including at least one notification message to extract information corresponding to a notification object of the at least one notification message; and
produce an output file, wherein states of the notification object have been pre-computed.

65. The apparatus of claim 64, wherein the processor is further configured to parse a real time transport protocol reception hint track to identify a reference to the notification object from a generic message part of the at least one notification message.

66. The apparatus of claim 64, wherein the processor is further configured to maintain a notification object lifecycle model for the notification object.

67. The apparatus of claim 66, wherein the processor is further configured to create at least one index representative of changes to the states of the notification object.
